(19) United States
(12) Patent Application Publication
(10) Pub. No.: US 2023/0396686 A1
(43) Pub. Date: Dec. 7, 2023

(54) CONFIGURABLE AND ADAPTIVE RESILIENCY IN MICROSERVICE ARCHITECTURES

(71) Applicant: INTERNATIONAL BUSINESS MACHINES CORPORATION, ARMONK, NY (US)

(72) Inventors: Varun Ojha, Panchkula (IN); Ana C Biazetti, Cary, NC (US)

(21) Appl. No.: 17/805,559

(22) Filed: Jun. 6, 2022

(51) Int. Cl. H04L 67/51; H04L 41/16; H04L 41/0654; H04L 41/0677

(52) U.S. Cl. CPC H04L 67/51; H04L 41/16; H04L 41/0654; H04L 41/0677

(57) ABSTRACT

A computer-implemented method, a computer system and a computer program product configure and adapt resiliency within a microservice architecture. The method includes receiving a resiliency policy from a client at a primary microservice. The method also includes determining a resiliency window based on the resiliency policy and a baseline response time. In addition, the method includes invoking a dependent microservice, where the resiliency window is also sent to the dependent microservice. Lastly, the method includes indicating a failure condition to the client when a consumed window of the dependent microservice is greater than the resiliency window.

### BACKGROUND

Embodiments relate generally to the field of software architecture, and more specifically, to configuring and adapting a resiliency metric in a microservice architecture of a distributed computing system.

It may be common in the current technology ecosystem to employ distributed computing systems for the provision of software applications such as a content streaming service or an Internet search service in highly scaled computing environments. In such systems, software applications may be composed of a substantial number of different modules that are designed to work together to provide the functionality of the overall application. Rather than writing a single stand-alone application that may provide an online content streaming service, the functionality may be provided by tens or even hundreds of smaller software modules, or “microservices,” each designed to perform a specific set of tasks and, when aggregated, may be designed to provide the overall functionality of the software application. The wide variety of possible functions provided by a software application architecture composed of microservices and the diversity of clients that may be served by such software applications mean that any software application using the microservice architecture must be robust and highly resilient so that the software application can be effective in providing services to users.

### SUMMARY

An embodiment is directed to a computer-implemented method for configuring and adapting resiliency within a microservice architecture. The method may include receiving a resiliency policy from a client at a primary microservice. The method may also include determining a resiliency window based on the resiliency policy and a baseline response time. In addition, the method may include invoking a dependent microservice, where the resiliency window is also sent to the dependent microservice. Lastly, the method may include indicating a failure condition to the client when a consumed window of the dependent microservice is greater than the resiliency window.

In another embodiment, the method may include modifying the resiliency window by deducting the consumed window of the dependent microservice from the resiliency window. In this embodiment, the method may also include invoking a second dependent microservice, where a modified resiliency window is also sent to the second dependent microservice. Lastly, in this embodiment, the method may include indicating a failure condition to the client when a consumed window of the second dependent microservice is greater than the modified resiliency window.

In a further embodiment, the method may include receiving the resiliency window from the primary microservice at the dependent microservice. In this embodiment, the method may also include determining whether an initial execution of the dependent microservice is successful and a required retry time. Lastly, in this embodiment, the method may include indicating a failure condition to the primary microservice when the initial execution of the dependent microservice is not successful and the required retry time is greater than the resiliency window.

In yet another embodiment, the method may include determining a retry wait time when the initial execution of the dependent microservice is not successful and the required retry time is not greater than the resiliency window. Also, in this embodiment, the method may include sending the consumed window to the primary microservice, wherein the consumed window is the retry wait time.

In an additional embodiment, the resiliency window may be determined with a machine learning model that predicts resiliency requirements of clients with respect to software applications.

In another embodiment, the indicating the failure condition to the client may further include updating the machine learning model.

In yet another embodiment, the baseline response time may be determined with a machine learning model that predicts response time of a microservice based on prior interactions.

In addition to a computer-implemented method, additional embodiments are directed to a system and a computer program product for configuring and adapting resiliency within a microservice architecture.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts an example microservices interaction diagram according to an embodiment.

FIG. 3 depicts a flow chart diagram for configuring and adapting resiliency within a microservice architecture according to an embodiment.

FIG. 4 depicts a cloud computing environment according to an embodiment.

FIG. 5 depicts abstraction model layers according to an embodiment.

### DETAILED DESCRIPTION

Distributed computing systems may be employed to provide software applications such as a content streaming service or an Internet search service in highly scaled computing environments, where the utilization of a “microservice architecture” may have multiple advantages. “Microservice architecture” may refer to a particular way of designing software applications as suites of independently deployable microservices. These microservices may run in their own process and communicate with each other over a network to collectively fulfill a goal using technology-agnostic and lightweight protocols such as Hypertext Transfer Protocol (HTTP) with a bare minimum of centralized management. Microservices may be implemented using different programming languages, databases, or hardware and software environments, depending on what fits best for the specific microservice. Microservices may be small in size, messaging-enabled, autonomously developed, independently deployable, and built and released with automated processes. Examples of environments where microservice architectures may typically be used include cloud-native applications, serverless computing, and applications using lightweight container deployment.

Advantages normally associated with microservice architectures include, for instance, compartmentalizing the development of the overall software application, since each stand-alone microservice can be assigned to a small group of programmers for implementation. In addition, the modularity of the software solution may be enhanced, since individual microservices can be easily removed and replaced with updated microservices that perform the same task. Another possible advantage may be that such modularized design may allow the software application to be easily distributed and redistributed over multiple different compute nodes (either physical or virtual) depending on the configuration of the different microservice.

In addition to the advantages above, the microservice architecture may be more vulnerable to transient network failures and outages and, as a result, a higher premium may be placed on implementing resiliency into the microservice architecture. Resiliency measures that may be commonly implemented include service level retries for transient failures, e.g., exponential backoff retry strategy, or patterns such as circuit breaker, bulkhead or timeouts for efficiency. However, as pre-decided and static, these practices do not account for a variety of clients that may expect different behaviors and response times from the same backend API or microservices. More specifically, when a software application depends on asynchronous APIs with dependent microservices, there may be long delays in notifying the application about whether the transaction was successful or not. As an example of the difference between potential clients, a loosely coupled programmatic client using a fire and forget integration pattern may not implement client side retries and would therefore expect a high level of resiliency from the backend APIs to minimize failures while a user interface (UI) client would be expected to be constantly responsive and would therefore expect quick response times from the backend APIs because the goal would be to get control back into a user's hands as soon as possible even when there are failures within the software application or the related microservices.

It may be useful to provide an automated method or system where resiliency may be configured and adapted based on the client that may be requesting the software application and dependent microservices since the same backend API may need a higher resiliency for certain clients and lower resiliency setting, or act as a fail-fast system, for other clients. Such a method may calculate a resiliency window from known behaviors of the microservices and the requirements of the client that may be used throughout the software application and microservice architecture to more easily adapt to present conditions. This configuration and adaptability may, in turn, improve the ability of the software application, as well as the computer system, to provide services to user in the face of network failures and outages, while maintaining the advantages present in the microservice architecture that have been described above.

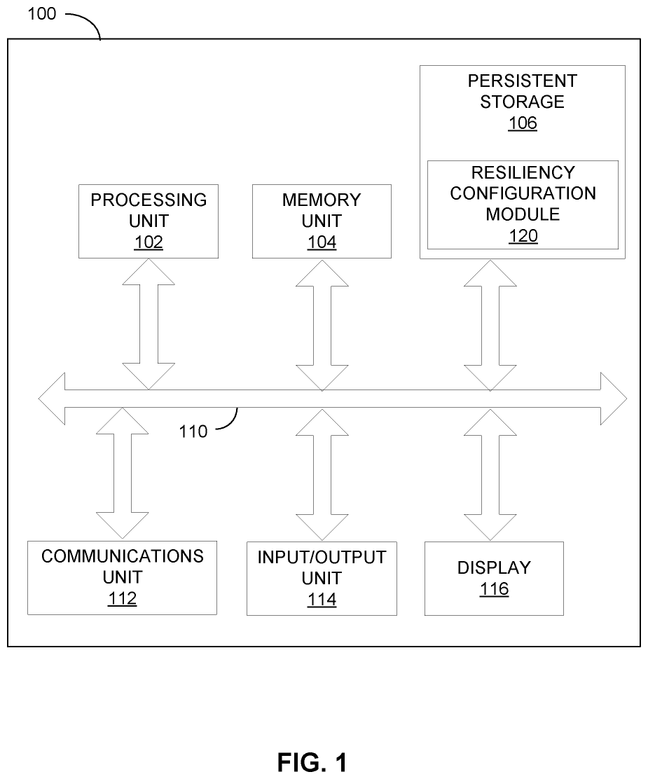

Referring now to FIG. 1, there is shown a block diagram illustrating a computer system 100 which may be embedded in an edge server in an embodiment. In another embodiment, the computer system 100 may be embedded in a client device or mobile client device, examples of which include: a mobile phone, smart phone, tablet, laptop, a computing device embedded in a vehicle, a wearable computing device, virtual or augmented reality glasses or headset, and the like. It should be appreciated that FIG. 1 provides only an illustration of one implementation and does not imply any limitations with regard to the environments in which different embodiments may be implemented. Many modifications to the depicted environments may be made based on design and implementation requirements. For example, computer system 100 may be implemented in hardware only, software only, or a combination of both hardware and software. Computer system 100 may have more or fewer components and modules than shown, may combine two or more of the components, or may have a different configuration or arrangement of the components. Computer system 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of computer system 100 may be co-located or distributed, or the system could run as one or more cloud computing “instances,” “containers,” and/or “virtual machines,” as known in the art.

As shown, a computer system 100 includes a processor unit 102, a memory unit 104, a persistent storage 106, a communications unit 112, an input/output unit 114, a display 116, and a system bus 110. Computer programs such as the resiliency configuration module 120 may be stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor unit 102 gives to memory unit 104 along with a request to read and/or write. Usually, the reading and interpretation of an encoded instruction at an address causes the processor unit 102 to fetch a subsequent instruction, either at a subsequent address or some other address. The processor unit 102, memory unit 104, persistent storage 106, communications unit 112, input/output unit 114, and display 116 interface with each other through the system bus 110.

Examples of computing systems, environments, and/or configurations that may be represented by the computer system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computer system 100 may also include a communications unit 112 such as TCP/IP adapter cards, wireless Wi-Fi interface cards, or 3G or 4G wireless interface cards or other wired or wireless communication links. Communication between mobile devices may be accomplished via a network and respective network adapters or communication units 112. In such an instance, the communication network may be any type of network configured to provide for data or any other type of electronic communication. For example, the network may include a local area network (LAN), a wide area network (WAN), a virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof.

The computer system 100 may be used for configuring and adapting a resiliency window for microservices within a software microservice architecture, where the resiliency window may define how a subject microservice may operate and respond before returning a failure condition. In particular, a resiliency determination module 120 may determine the resiliency window according to a resiliency policy that may be passed to the microservice by a client or may be set based on a known baseline response time for the microservice. For example, a resiliency policy may indicate one of a set of preconfigured templates labeled, for instance, “low”, “medium” or “high.” These labels may indicate a percentage of a known baseline response time to use for a resiliency window. Examples of this indication may be that “low” indicates 50%, “medium” may indicate 100% and “high” 150%, in which case a calculation may be made by the resiliency determination module based on the baseline response time for the microservice. Alternatively, the resiliency window may be predicted using a machine learning model, where the prediction may take into account prior interactions between microservices or between the overall software application and a client. The machine learning model may also be trained with historical data about the microservice relating to the length of time that the microservice takes to complete any task in any environment. This resiliency window may be processed by the microservice after the first execution of the microservice to determine if sufficient time remains for the microservice to respond to the request of the client after the microservice has executed once. In the event that there remains sufficient time, the microservice may respond to a request but otherwise, a failure condition may be reported by the microservice. It is important to note that the microservice will execute once prior to any check of the resiliency window and the resiliency window will be used for any retry of the microservice.

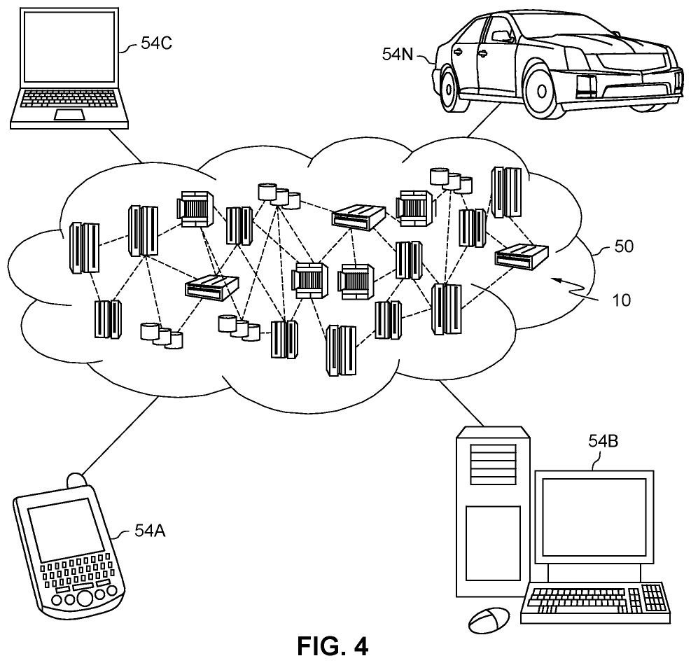

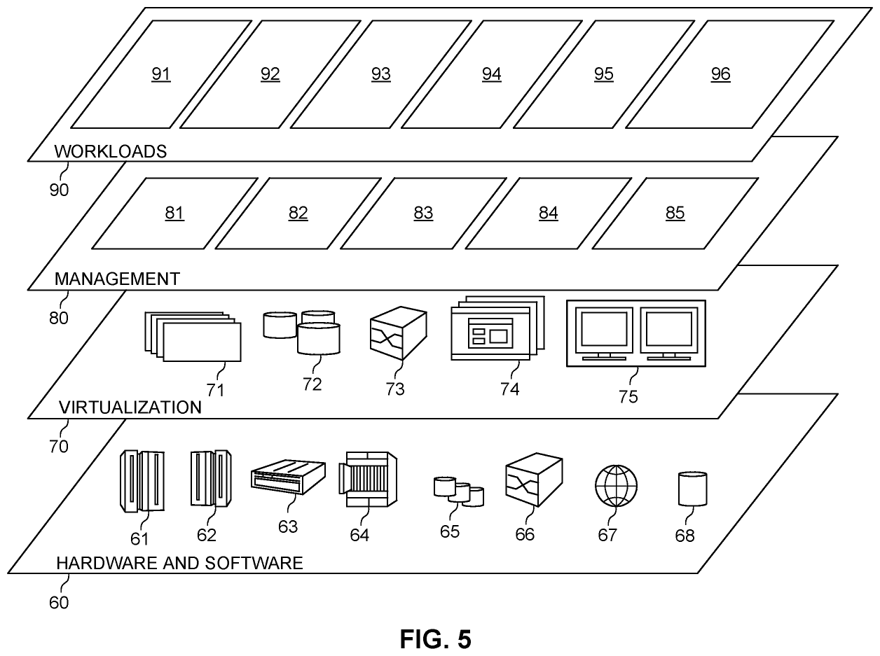

As will be discussed below with reference to FIGS. 4 and 5, computing system 100 may also operate in a cloud computing service model, such as Software as a Service (SaaS), Platform as a Service (PaaS), or Infrastructure as a Service (IaaS). Any computing system 100 may also be located in a cloud computing deployment model, such as a private cloud, community cloud, public cloud, or hybrid cloud.

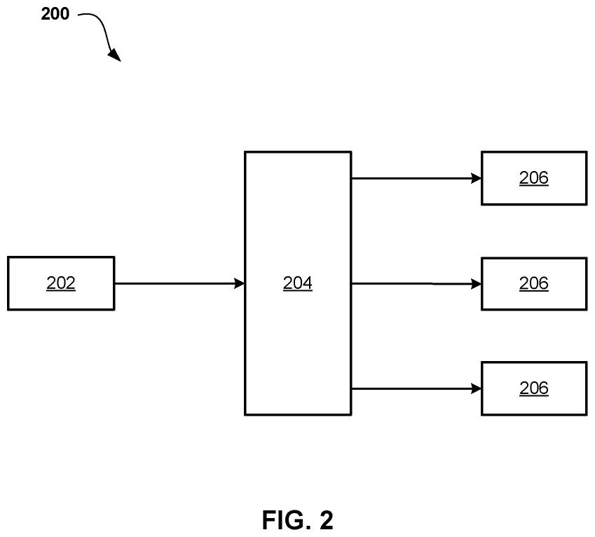

Referring to FIG. 2, a microservice interaction diagram corresponding to an example 200 is depicted in accordance with an embodiment. In this example, a primary microservice 204 is shown along with three dependent microservices 206. It should be noted that there are many possible configurations of microservices within a microservice architecture, of which the example of FIG. 2 is only one, and there may be hundreds or even thousands of microservices in an actual microservice architecture. In addition, the dependent microservices 206 depicted in FIG. 2 may themselves have dependent microservices in a hierarchical structure that may have more layers. These additional layers and microservices have been omitted from FIG. 2 for illustrative brevity.

In the example of FIG. 2, the primary microservice 204 may receive a resiliency policy from a client 202 and determine a resiliency window, expressed as a time value, which may be a variable that is passed to the dependent microservices 206 at the time of invocation. As a starting point, the primary microservice 204 may have a baseline response time for the primary microservice itself and may also have a baseline response time for each dependent microservice 206 such that an overall baseline response time may be calculated. The resiliency policy that may be received from a client 202 may express a preset level of resiliency, e.g, “low”, “medium” or “high,” or may express a set percentage of response time that a client 202 may require, e.g., if the overall baseline response time is 6 seconds and the policy requires 100%, then the resiliency window would be 6 seconds. In addition, the resiliency policy may also set a specific amount of time that the client may require for resiliency.

At this point, the resiliency window that has been calculated may be passed to a dependent microservice 206 along with a request for invocation of the dependent microservice 206. The dependent microservice 206 may execute according to the request and if the execution is successful, this may be reported to the primary microservice 204. In the event that the execution is not successful, the dependent microservice 206 may process the resiliency window to determine if sufficient time remains for the dependent microservice 206 to retry execution of the request. If the resiliency window is smaller than the estimated response time for a retry, then the dependent microservice 206 may return a failure condition to the primary microservice 204. However, if the resiliency window is greater than the estimated response time for a retry, then the dependent microservice 206 may retry the request and respond to the primary microservice 204 when complete. Once the primary microservice 204 has received a response from the dependent microservice 206, whether successful or not, the primary microservice 204 may deduct the time taken for retries of the dependent microservice 206, as reported by the dependent microservice 206, from the resiliency window. An alternative value for the amount of time to deduct from the resiliency window may be a difference between a known baseline response time for the dependent microservice 206 and the time taken from invocation of the dependent microservice 206 to the present time. After any adjustment by the primary microservice 204, a modified resiliency window may now be used for subsequent requests to further dependent microservices 206. It is important to note that if the dependent microservice 206 was successful in its first execution, then no time may be deducted from the resiliency window. Only time that is spent on retries by the dependent microservice 206 may be considered at this point.

The process may be repeated with the next dependent microservice 206 and, while processing of requests may continue as normal regardless of the resiliency window, retries may only be attempted as long as there is a positive value for the resiliency window, or the estimated response time is less than the remaining resiliency window. If the resiliency window reaches zero at any point prior to a retry being attempted, or the time spent on retries by a dependent microservice 206 or the primary microservice 204 is greater than the remaining resiliency window, then a failure condition may be reported to the client 202, which may then take appropriate action based on the reported failure. It is important to note that the resiliency window may not interfere with the normal processing of requests through a software application and may only determine whether a retry may be attempted in the event of a failure of any microservice in the software application.

It should be noted that individual decisions about whether to continue with a request or report a failure condition may be made at any level in the hierarchy shown in FIG. 2. However, actual management of the resiliency window and what is passed along to each dependent microservice 206 to make that decision remains with the primary microservice 204. One of ordinary skill in the art will recognize that there may be many layers to the hierarchical structure shown in FIG. 2, as mentioned above. For example, a microservice that may be a dependent microservice 206 in FIG. 2 may itself have microservices that rely on invocations from the microservice. In this instance, the microservice may act as the primary microservice and have one or more dependent microservices connected to it. In this scenario, the microservice may not communicate with the client directly but rather with the microservices further up the hierarchical structure. In this multi-layer system, the decisions are passed along the layers of the structure and, while a single microservice may perform the functions of both the primary and dependent microservices, these decisions are separate and made as described herein. In other words, while a microservice such as outlined in FIG. 2 as dependent microservice 206 may also be a primary microservice in another layer of services below what is shown in FIG. 2, where that microservice may be managing the resiliency window for the further microservices, the primary microservice 204 may not delegate its overall function as the controller for the application to other microservices.

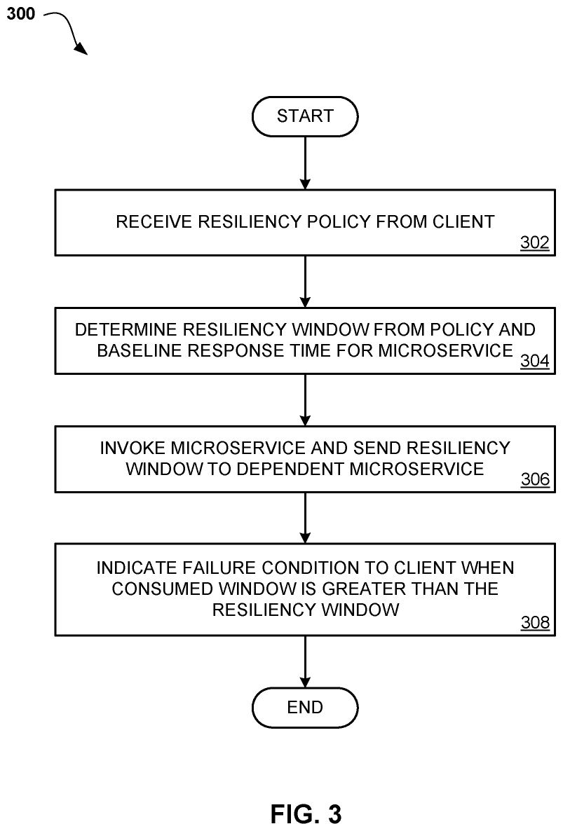

Referring to FIG. 3, an operational flowchart illustrating a process 300 that is depicted according to at least one embodiment. At 302, a resiliency policy may be received from a client, e.g., client 202. along with a request for service from a software application. A client may be a software application that makes a request of another software application, e.g., a user interface application on a web site, or in some way may require output from a software application. The client may be user-facing software or any kind of software application that may need a service that may be provided by the software application or a set of microservices such as the architecture depicted in FIG. 2. In addition to making a request of the software application, the client may indicate, through the resiliency policy, a requirement for the software application to respond to the request. The resiliency policy may describe to the software application how the microservices should enforce resiliency between the microservices. The resiliency policy may be preconfigured according to the client making the request, for example the software application may have a set resiliency policy whenever a specific application or type of application makes a request.

Alternatively, the client may pass information to the software application explicitly calling out the resiliency level that may be required of the software application. The resiliency policy may be expressed to the software application as an amount of time or else may be expressed as a level, e.g., “low”, “medium” or “high,” in which case specific profiles may be kept by the software application to convert a level into a time value. In another embodiment, the resiliency may be expressed as a percentage of response time for the software application. In this embodiment, a baseline response time, as explained below, may be calculated for the software application and used to further calculate the resiliency as a time value in further steps of the process 300. One of ordinary skill in the art will recognize that it is not required for the resiliency policy to express resiliency in a specific way. It is only required at this step to receive the information to be able to determine a resiliency window in the next step as a time value.

At 304, the resiliency window may be determined from the resiliency policy and also using a baseline response time for the microservice. As explained, this resiliency window may be a time value that is a function of a baseline response time for the software application and the resiliency policy that may be received at 302. In the example of FIG. 2, the baseline response time used to determine the resiliency window may include a combined baseline response time for primary microservice 204 and also dependent microservices 206. As an example, if the baseline response time for the combined application were 6 seconds and the resiliency policy indicates a high resiliency level, which may be 150% as an example, then the resiliency window would be 9 seconds in this example. The resiliency window acts as an overall maximum response time allowed for retries of requests within the entire software application, which in the example of FIG. 2 includes a primary microservice and multiple dependent microservices. This is equivalent to a maximum of extra time beyond known baseline response times before a failure condition may be reported to a client.

The baseline response time, and therefore also the resiliency window, may be determined through a profile or preset time that may be assigned to the microservice. However, as a software application processes multiple requests and invokes microservices within the architecture of the application, it may be learned that a known baseline response time, which may be preconfigured according to a template, may not be accurate for a given microservice. Therefore, in an embodiment, a supervised machine learning model may be trained to predict response time of a microservice based on past interactions between microservices or between a microservice and various types of clients. One or more of the following machine learning algorithms may be used: logistic regression, naive Bayes, support vector machines, deep neural networks, random forest, decision tree, gradient-boosted tree, multilayer perceptron, and one-vs-rest. In an embodiment, an ensemble machine learning technique may be employed that uses multiple machine learning algorithms together to assure better prediction when compared with the prediction of a single machine learning algorithm. In this embodiment, training data for the model may include prior transactions between microservices or between specific clients and microservices with a goal of learning the requirements of clients in addition to the capabilities of individual microservices. The prediction results may be stored in a database so that the data is most current, and the output would always be up to date.

It should be noted that a separate machine learning model, using the same scheme as that described above, may also be used to predict the resiliency policy that may be received in 302. In the course of making requests to software applications, it may be learned how clients require resiliency from the software application. As a result, training data may be gathered from the interactions of clients and software applications and adjustments made to the resiliency policy in a customized way for each client that may invoke a primary microservice as part of a request. While adjustments may be made directly to the resiliency window using the above machine learning model, in this model the prediction result may be to assign a certain level, described above as “low”, “medium” or “high”, to specific clients when they are recognized in process 300.

At 306, a microservice, e.g., dependent microservice 206, may be invoked by the primary microservice, e.g., primary microservice 204, and the resiliency window may be passed as a time value to the microservice that has been invoked. The microservice may process the request that has been invoked by the primary microservice and it should be noted that the status of the resiliency window does not affect the first invocation of the microservice. In other words, the microservice is required to run once before the resiliency window may be checked by the microservice and may only be checked if the microservice fails in its initial invocation. Therefore, if the microservice succeeds in processing the request, this may immediately be reported back to the primary microservice and, in addition, the microservice may also report that no time was taken for retries, for example as a “consumed window” variable with a value of zero. However, in the event that the initial invocation fails and a retry becomes necessary, the resiliency window may be checked and, if the time that the microservice calculates to attempt a retry of the request is greater than the current resiliency window, the microservice may continue with the retry of the service request. At this point, the actual time taken in waiting for a retry may be monitored by the microservice. If the resiliency window is less than the time needed for a retry, then the microservice may indicate a failure condition to the primary microservice, which may then indicate a failure to the client. It should be noted here that this process may be repeated each time that the microservice may decide that a retry is necessary and a failure condition has not already been reported back to the primary microservice. Once the microservice either successfully completes the request or needs to report a failure condition, the state of the resiliency window, e.g., the “consumed window” variable described above, may also be reported back to the primary microservice.

At 308, the primary microservice may continue processing both the service request from the client and the resiliency window. If the dependent microservice has reported a failure condition, then the primary microservice may notify the client of the failure. However, if the dependent microservice has succeeded in processing the request, then the primary microservice may modify the resiliency window by deducting the amount of time that may have spent by the dependent microservice waiting for retries from the current resiliency window and if there is still time remaining after the deduction, which would equate to a non-zero resiliency window or a resiliency window that has not been fully consumed, then retries may continue to be attempted. One of ordinary skill in the art would recognize that there are multiple ways to determine the amount of time that should be deducted from the resiliency window. While the dependent microservice may report back to the primary microservice the actual time spent on waiting for retries in its operation, the primary microservice may also use a prediction of response time for further microservices or a baseline response time that is preconfigured for additional microservices. It is not required that a “consumed window” variable be passed between the microservices. It should be noted that the resiliency window, and any modification or deduction of the resiliency window, may not interfere with the normal process of making requests between microservices and may only determine whether or not a retry may be attempted in the event of failure in the normal process.

As the request continues, this may require another invocation of a separate microservice and follow the same process using a modified resiliency window, e.g., a resiliency window that has been lowered by the amount of time that the first microservice spent on retries. This separate microservice may operate exactly as the dependent microservice above. That is to say that the separate microservice is required to run once and then, based on whether the invocation is successful, either report a successful completion of the request and zero consumed resiliency window to the primary microservice or attempt a retry and monitor the time spent waiting for the retry, exactly as occurred with the previous dependent microservice. In attempting the retry, the modified resiliency window may be checked and the retry may not proceed if the modified resiliency window is too small, at which point a failure condition may also be reported to the primary microservice. The separate microservice may then indicate a failure condition and an amount of resiliency window consumed by the separate microservice to the primary microservice, which may again modify the resiliency window as above and determine if the primary microservice should indicate a failure condition based on whether the resiliency window has been fully consumed, i.e., the resiliency window remains greater than zero. This resiliency window that is further modified may now be used for any further dependent microservices that may be present and the process 300 may continue iteratively until all dependent microservices have successfully completed the request for service. As mentioned above, the iterative process of modifying and checking the resiliency window may only determine whether a retry may be attempted in the event of a failure in the normal process. While a failure condition may be reported to the primary microservice or the client in the event that the resiliency window has been consumed, this may only occur if a failure has occurred in the normal operation of the software application. A failure condition may be indicated at any time during the iterative process described above, such as if a failure condition has been indicated by a dependent microservice. It should be noted that the primary microservice may also have processing tasks related to a service request in addition to those of dependent microservices and therefore may independently indicate a failure condition to the client even if all dependent microservices successfully complete the service request. However, as mentioned above, any calculation of resiliency may only determine if a retry may be attempted and therefore, every microservice in the configuration is required to run once before the resiliency window is used in a software application.

One of ordinary skill in the art may recognize that there are multiple ways for a microservice to indicate a failure condition to another microservice or to a client, including errors such as connection closed, timeout, dependency service/component unavailable, dependency service/component returns a retriable error, request throttling by a server or Multi Value Concurrency Control (MVCC) errors. It should be noted that this list includes examples and is not intended to be exhaustive.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and microservice resiliency configuration 96, which may refer to configuring and adapting a resiliency metric within a microservice architecture.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for configuring and adapting resiliency within a microservice architecture, the method comprising:
obtaining prior interactions between a client and the microservice architecture from a server and determining a resiliency policy for the microservice architecture and the client based on the prior interactions between the client and the microservice architecture, wherein the microservice architecture includes a primary microservice and a dependent microservice;
generating a resiliency window based on the resiliency policy for the microservice architecture and the client, wherein the resiliency window indicates a maximum time allowed for request retries within the microservice architecture;
requesting an invocation of the dependent microservice, wherein the resiliency window is also sent to the dependent microservice and the invocation of the dependent microservice includes at least one retry of a request; and
indicating a failure condition to the client when a time to complete the at least one retry of the request is greater than the resiliency window.

2. The computer-implemented method of claim 1, wherein the microservice architecture also includes a second dependent microservice, further comprising:
modifying the resiliency window by deducting the time to complete the at least one retry of the request from the resiliency window;
requesting a further invocation of the second dependent microservice, wherein a modified resiliency window is also sent to the second dependent microservice and the further invocation of the second dependent microservice includes at least one further retry of a further request; and
indicating a failure condition to the client when an additional time to complete the at least one further retry of the further request is greater than the modified resiliency window.

3. The computer-implemented method of claim 1, further comprising:
receiving the resiliency window from the primary microservice at the dependent microservice;
determining that an initial execution of the dependent microservice is not successful and a required retry time; and
indicating a failure condition to the primary microservice when the required retry time is greater than the resiliency window.

4. The computer-implemented method of claim 3, further comprising:
determining a retry wait time when the initial execution of the dependent microservice is not successful and the required retry time is not greater than the resiliency window; and
sending the retry wait time to the primary microservice as the time to complete the at least one retry of the request.

5. The computer-implemented method of claim 1, wherein the determining the resiliency window uses a machine learning model that predicts resiliency requirements of clients based on historical microservice interaction data within software applications.

6. The computer-implemented method of claim 5, wherein the indicating the failure condition to the client further includes updating the machine learning model.

7. (canceled)

8. A computer system for configuring and adapting resiliency within a microservice architecture, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
obtaining prior interactions between a client and the microservice architecture from a server and determining receiving a resiliency policy for the microservice architecture and the client based on the prior interactions between the client and the microservice architecture, wherein the microservice architecture includes a primary microservice and a dependent microservice;
generating a resiliency window based on the resiliency policy for the microservice architecture and the client, wherein the resiliency window indicates a maximum time allowed for request retries within the microservice architecture;
requesting an invocation of the dependent microservice, wherein the resiliency window is also sent to the dependent microservice and the invocation of the dependent microservice includes at least one retry of a request; and
indicating a failure condition to the client when a time to complete the at least one retry of the request is greater than the resiliency window.

9. The computer system of claim 8, wherein the microservice architecture also includes a second dependent microservice, further comprising:
modifying the resiliency window by deducting the time to complete the at least one retry of the request from the resiliency window;
requesting a further invocation of the second dependent microservice, wherein a modified resiliency window is also sent to the second dependent microservice and the further invocation of the second dependent microservice includes at least one further retry of a further request; and
indicating a failure condition to the client when an additional time to complete the at least one further retry of the further request is greater than the modified resiliency window.

10. The computer system of claim 8, further comprising:
receiving the resiliency window from the primary microservice at the dependent microservice;
determining that an initial execution of the dependent microservice is not successful and a required retry time; and
indicating a failure condition to the primary microservice when the required retry time is greater than the resiliency window.

11. The computer system of claim 10, further comprising:
determining a retry wait time when the initial execution of the dependent microservice is not successful and the required retry time is not greater than the resiliency window; and
sending the retry wait time to the primary microservice as the time to complete the at least one retry of the request.

12. The computer system of claim 8, wherein the determining the resiliency window uses a machine learning model that predicts resiliency requirements of clients based on historical microservice interaction data within software applications.

13. The computer system of claim 12, wherein the indicating the failure condition to the client further includes updating the machine learning model.

14. (canceled)

15. A computer program product for configuring and adapting resiliency within a microservice architecture, comprising:
a computer readable storage medium having program instructions embodied therewith, the program instructions executable by a processor to cause the processor to perform a method comprising:
obtaining prior interactions between a client and the microservice architecture from a server and determining a resiliency policy for the microservice architecture and the client based on the prior interactions between the client and the microservice architecture, wherein the microservice architecture includes a primary microservice and a dependent microservice;
generating a resiliency window based on the resiliency policy for the microservice architecture and the client, wherein the resiliency window indicates a maximum time allowed for request retries within the microservice architecture;
requesting an invocation of the dependent microservice, wherein the resiliency window is also sent to the dependent microservice and the invocation of the dependent microservice includes at least one retry of a request; and
indicating a failure condition to the client a time to complete the at least one retry of the request is greater than the resiliency window.

16. The computer program product of claim 15, wherein the microservice architecture also includes a second dependent microservice, further comprising:
modifying the resiliency window by deducting the time to complete the at least one retry of the request from the resiliency window;
requesting a further invocation of the second dependent microservice, wherein a modified resiliency window is also sent to the second dependent microservice and the further invocation of the second dependent microservice includes at least one further retry of a further request; and
indicating a failure condition to the client when an additional time to complete the at least one further retry of the further request is greater than the modified resiliency window.

17. The computer program product of claim 15, further comprising:
receiving the resiliency window from the primary microservice at the dependent microservice;
determining that an initial execution of the dependent microservice is not successful and a required retry time; and
indicating a failure condition to the primary microservice when the required retry time is greater than the resiliency window.

18. The computer program product of claim 17, further comprising:
determining a retry wait time when the initial execution of the dependent microservice is not successful and the required retry time is not greater than the resiliency window; and
sending the retry wait time to the primary microservice as the time to complete the at least one retry of the request.

19. The computer program product of claim 15, wherein the determining the resiliency window uses a machine learning model that predicts resiliency requirements of clients based on historical microservice interaction data within software applications.

20. The computer program product of claim 19, wherein the indicating the failure condition to the client further includes updating the machine learning model.
